(19) United States
(12) Patent Application Publication
(10) Pub. No.: US 2010/0085493 A1
(43) Pub. Date: Apr. 8, 2010

(54) CABINET ASSEMBLED WITH FLAT-PANEL TELEVISION

(76) Inventor: Chun-Chi Liao, Taipei (TW)

Correspondence Address: BIRCH STEWART KOLASCH & BIRCH, PO BOX 747, FALLS CHURCH, VA, 22040-0747, US

(21) Appl. No.: 12/247,691

(22) Filed: Oct. 8, 2008

(51) Int. Cl. H04N 5/64

(52) U.S. Cl. 348/836; 348/E05.128

(57) ABSTRACT

A cabinet assembled with a flat-panel television includes a frame, a TV assembly, a bracket device, and a driver device. A groove opening is defined on a top surface of the frame to allow the TV assembly to pass through. The TV assembly is mounted on the bracket device and disposed inside of the frame. The bracket device is driven by the driver device to move upward or downward. When the bracket device is driven to the highest position, the TV assembly is exposed out of a top of the frame. When the bracket device is driven to the lowest position, the TV assembly is completely received inside of the frame, a top edge of the TV assembly is coplanar with the top of the frame, and the cabinet can work as a regular cabinet or a table.

### BACKGROUND OF THE INVENTION

1. Field of the Invention

The present invention relates generally to a cabinet assembled with a flat-panel television, and more particularly to a cabinet and a flat-panel television that can be exposed outside or hidden inside of the cabinet.

2. The Prior Arts

Flat-panel televisions are lighter and much thinner than traditional CRT televisions, and picture resolution of the flat-panel TV is greatly improved in recent years. Therefore the flat-panel televisions, including LCD televisions and plasma televisions, are becoming increasingly popular. Usually, the flat-panel TV is mounted on a wall, a TV stand, a cabinet, or an entertainment center. It is convenient but sometimes it does not match the home decoration. Moreover, the flat-panel television can be embedded in the wall. Thus, when the TV is not in use, it can be hidden behind a screen, a panel, etc. The flat-panel television can also be mounted on a TV bracket, thereby allowing the TV to rotate, tilt, or move horizontally or vertically. However, these latter two arrangements are costly, and damage the wall.

### SUMMARY OF THE INVENTION

A primary objective of the present invention is to provide a cabinet assembled with a flat-panel television. The flat-panel TV is disposed outside of cabinet when the TV is in use. When the TV is not in use, the flat-panel TV is completely received in the cabinet and thus the cabinet can work as a regular cabinet, a table, etc. The cabinet assembled with the flat-panel TV is low cost and versatile for home decoration.

The characteristic of the present invention is that the cabinet assembled with the flat-panel television includes a frame, a TV assembly, a bracket device, and a driver device. The TV assembly is mounted on the bracket device and disposed inside of the frame. The bracket device is driven by the driver device to move upward or downward. Therefore, when the bracket device is driven to the highest position, the TV assembly is exposed out of a top of the frame. When the bracket device is driven to the lowest position, the TV assembly is completely received inside of the frame and a top edge of the TV assembly is coplanar with the top of the frame. Then, the cabinet can work as a regular cabinet or a table.

In order to achieve the objective mentioned above, the frame includes a chamber to receive the TV assembly, the bracket device, and the driver device, and the chamber has a groove opening defined on a top surface thereof. The TV assembly is mounted on the bracket device, and the bracket device is connected with the driver device. The driver device is actuated to drive the bracket device, thereby moving the TV assembly upward or downward. At least a pair of speakers are mounted inside of the chamber and connected to the TV assembly. The frame also has a cover disposed at a front side thereof. The cover includes a hole and a switch to actuate the driver device is embedded in the hole. The user can use the switch or a remote control to move the TV assembly upward or downward. Therefore the TV assembly can be disposed outside of the frame or hidden inside of the frame. Further, the cabinet can be in any shape, size and style for home decoration without damaging the wall.

### BRIEF DESCRIPTION OF THE DRAWING

The present invention will be apparent to those skilled in the art by reading the following detailed description of a preferred embodiment thereof, with reference to the attached drawings, in which:

FIG. 1 is a perspective view showing a cabinet assembled with a flat-panel television according to the present invention;

FIG. 2 is an exploded view showing the cabinet assembled with the flat-panel television according to the present invention;

FIG. 3 is a schematic, front view showing the cabinet assembled with the flat-panel television according to the present invention, when a TV assembly is received in the cabinet;

FIG. 4 is a cross-sectional view showing the cabinet assembled with the flat-panel television according to the present invention, when the TV assembly is received in the cabinet; and

FIG. 5 is a cross-sectional view showing the cabinet assembled with the flat-panel television according to the present invention, when the TV assembly is exposed out of the cabinet.

### DETAILED DESCRIPTION OF THE PREFERRED EMBODIMENT

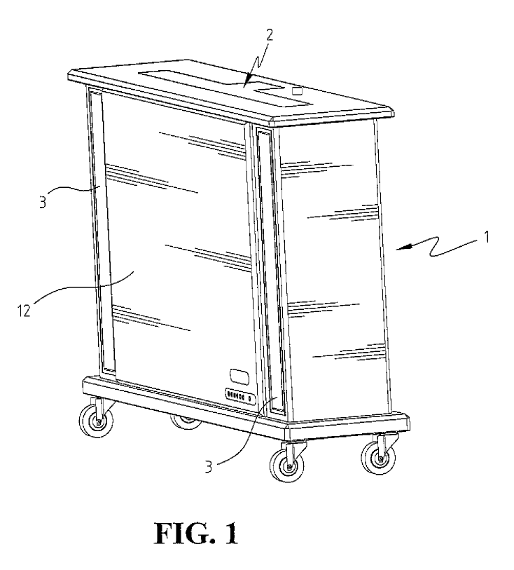

FIG. 1 is a perspective view showing a cabinet assembled with a flat-panel television according to the present invention. When the flat-panel TV is received in the cabinet, the cabinet can work as a regular cabinet or a table.

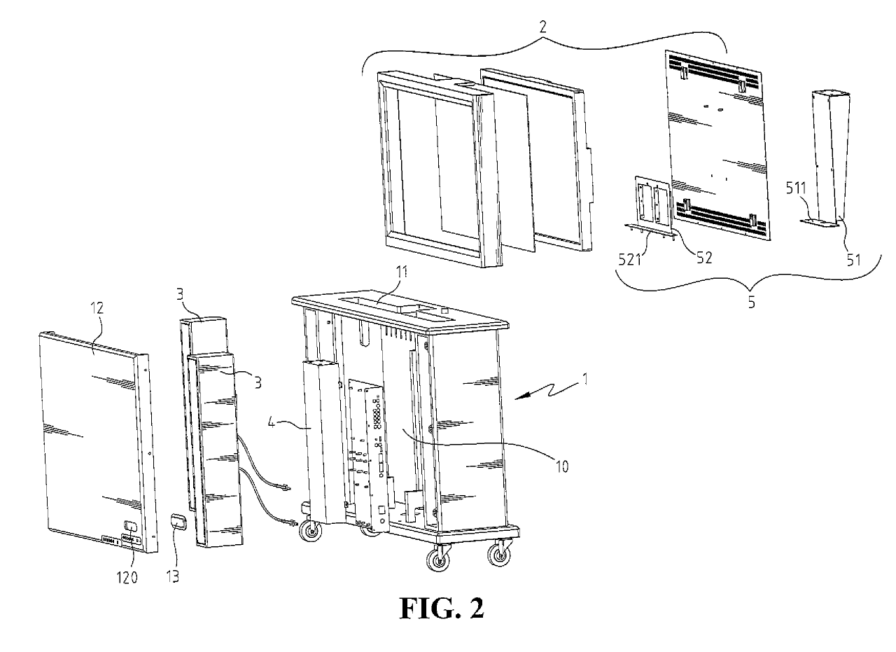

Referring to FIGS. 1 and 2, the cabinet assembled with the flat-panel television includes a frame 1, a TV assembly 2, at least two speakers 3, a driver device 4 and a bracket device 5. The frame 1 has a cover 12. A hole 120 is defined in a surface of the cover 12, and a switch 13 to control the driver device 4 is embedded into the hole 120. A groove opening 11, whose shape is corresponding to the TV assembly, is defined on a top surface of the frame 1. The cover 12 and the frame 1 form a receiving chamber 10 therebetween. The TV assembly 2, the speakers 3, the driver device 4 and the bracket device 5 are installed in the receiving chamber 10. The TV assembly 2 has TV frames and the flat-panel television assembled together. The bracket device 5 connected with the driver device 4 includes a first bracket 51 and a second bracket 52. The first bracket 51 has a first body (not labeled) and a first carrier plate 511 at a lower end thereof, and the second bracket 52 has a second body (not labeled) and a second carrier plate 521 at a lower end thereof. In this configure, the second bracket 52 is connected with the first bracket 51 and the second carrier plate 521 stacks on the first carrier plate 511. The TV assembly 2 is disposed on the second carrier plate 521 and fixed to the bracket device 5. Then, the TV assembly 2 and the bracket device 5 are disposed at a predetermined position in the receiving chamber 10 so that the TV assembly 2 is aligned with the groove opening 11. The driver device 4 includes an enclosure (not labeled) and a motor (not shown) arranged in the enclosure. Subsequently, a gear (not shown) of the driver device 4 is engaged with a rack (not shown) of the first bracket 51. Therefore, when the driver device 4 is actuated, the TV assembly 2 and the bracket device 5 can be driven upward or downward. The speakers 3 are connected to audio output of the TV assembly 5 as usual. Although it is not shown in detail that elements of the TV assembly 5, placement of the driver device 4 and the like, the spirits of the present invention is not damaged and the inventiveness of the invention is not denied because that is a general knowledge which is not directly related to this invention.

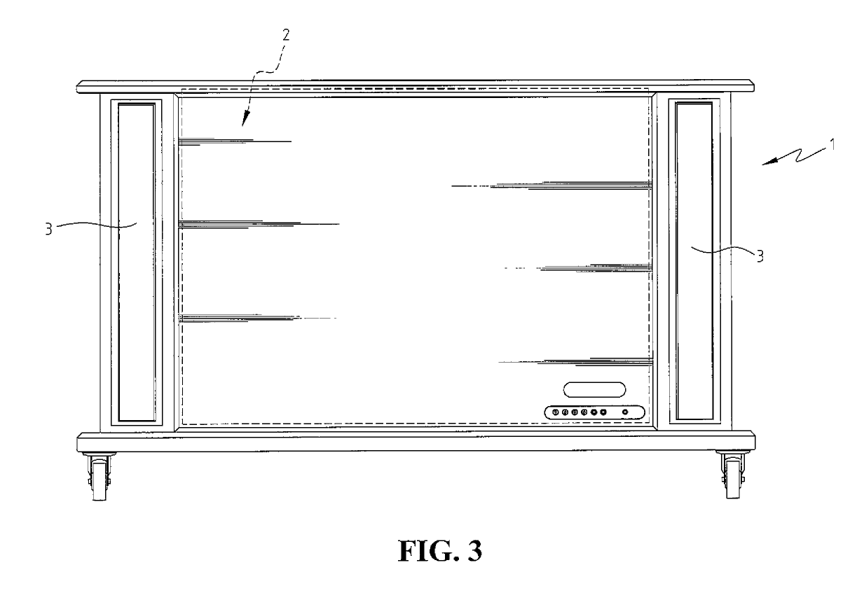

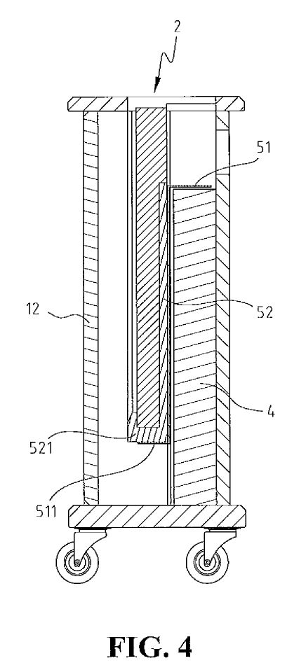

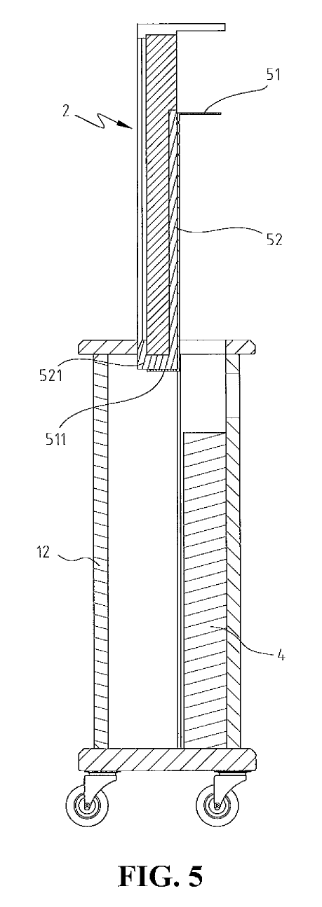

Referring to FIGS. 3 and 4, the driver device 4 drives the bracket device 5 to a lowest position. Thus, the TV assembly 2 is completely received in the frame 1, and a top edge of the TV assembly 2 is coplanar with a top surface of the frame 1. Then, the cabinet can work as a regular cabinet or a table. Referring to FIG. 5, when the user wants to watch television, just press the switch 13. The driver device 4 drives the bracket device 5 upward. Thus, the TV assembly 2 moves upward and passes through the groove opening 11 until the whole viewing screen of the TV assembly 2 is exposed out of the frame 1. Then, the cabinet works as a TV stand. The switch 13 may also control the power of the flat-panel TV. It is obvious that the driver device 4 can also be actuated by a remote control.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A cabinet assembled with a flat-panel television, comprising:
a frame having a receiving chamber and a groove opening defined on a top surface thereof;
a driver device disposed inside of the receiving chamber;
a bracket device disposed inside of the receiving chamber, and connected with and driven by the driver device to vertically move in one of an upward direction and a downward direction; and
a TV assembly mounted on the bracket device and disposed inside of the receiving chamber;
wherein the TV assembly is aligned with the groove opening, the driver device is capable of moving the bracket device and the TV assembly to pass through the groove opening.

2. The cabinet assembled with the flat-panel television as claimed in claim 1, wherein at least two speakers are installed in the receiving chamber and connected to audio output of the TV assembly.

3. The cabinet assembled with the flat-panel television as claimed in claim 1, further comprising a cover disposed at a front side of the frame;
wherein a hole is defined in a surface of the cover and a switch to control the cabinet assembled with the flat-panel television is embedded in the hole.
